(19) United States
(12) Patent Application Publication
(10) Pub. No.: US 2003/0156408 A1
(43) Pub. Date: Aug. 21, 2003

(54) Holiday lights compacting system

(76) Inventor: Matthew David Goodman, Ames, IA (US)

Correspondence Address: Matthew Goodman, 3303 West St., Ames, IA, 50014, US

(21) Appl. No.: 10/078,100

(22) Filed: Feb. 19, 2002

(51) Int. Cl. F21S 4/00

(52) U.S. Cl. 362/234; 362/227

(57) ABSTRACT

The Holiday Lights Compacting System (HLCS) solves the problems of light strings in two ways. Firstly, it allows one to organize the lights in such a way that they may be stored easily for years to come. Secondly, the method is not painstakingly laborious, but quick and convenient since the system is part of the light string itself. It uses a special socket shape made of the traditional electrical design and a small guide attached to the side. Through these guides runs a nylon cord along the length of the string. All sockets may be pushed along the guide string aligning themselves for storage or packaging in small spaces, eliminating the tendency to destroy or tangle holiday light strings.

### CROSS REFERENCES

There are no current cross-references. The classes and subclasses searched were: D11 (117,118,121); 362 (227,249); D26 (1,2,24,25); 315 (185); D8 (349,382)

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Light strings are a traditional western method of celebrating the winter holiday season and have recently begun to be used in celebrations of all kinds. There has been, however, a problem regarding easy seasonal storage of these lights. Tangles often lead to breakage of bulbs and inconvenience. Storage methods have been developed, but often these are as inconvenient as the untangling they are trying to prevent. There is a need for a light string storage system which is convenient and allows years of hassle free enjoyment.

### BRIEF SUMMARY OF INVENTION

The Holiday Lights Compacting System (HLCS) solves the problem of light strings in two ways. First, it allows one to organize the lights in such a way that they may be stored easily for years to come. Second, the method is not painstakingly laborious, but quick and convenient since the system is part of the light string. Affixed to the side of the plastic socket is a guide which allows the compacting of all the sockets in an orderly fashion. Then, the lights may be easily stored for the coming holiday season.

### BRIEF DESCRIPTION OF THE DRAWINGS

FIG. 1: FIG. 1 is a side view of one of the compacting guides with socket bulb and nylon guide string.

FIG. 2: FIG. 2 is a rear view of one of the guides with the bulb and socket showing the handedness of the hollow female end.

FIG. 3: FIG. 3 shows how the HLCS works and the look of the resulting light string.

### DETAILED SUMMARY OF INVENTION

The Holiday Lights Compacting System (HLCS) solves the problems of light strings in two ways. Firstly, it allows one to organize the lights in such a way that they may be stored easily for years to come. Secondly, the method is not painstakingly laborious, but quick and convenient since the system is part of the light string.

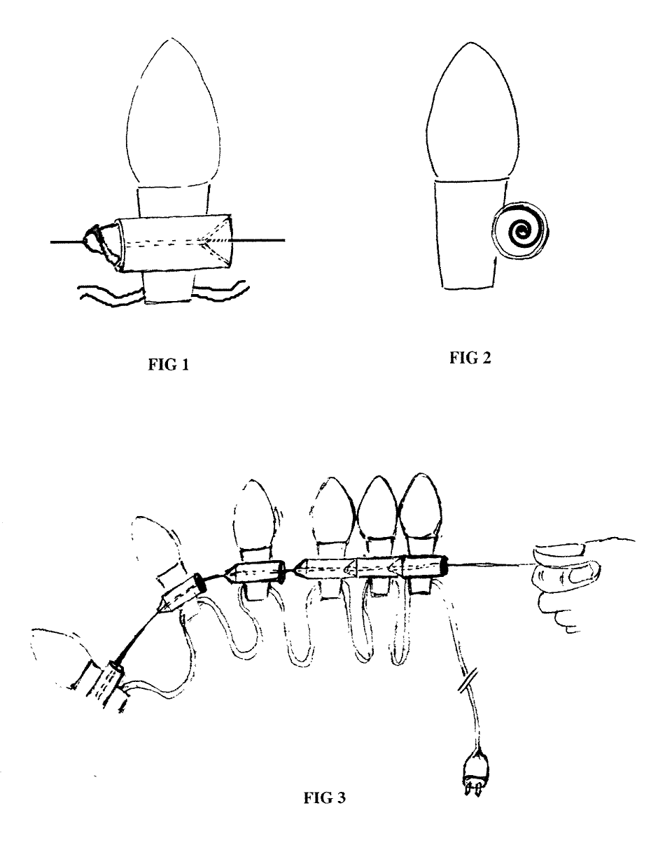

The system consists of a small change in the physical production of holiday lights, which yields a monumental change in convenience. The typical holiday light string consists of 1 to three wires wound through a series of plastic light sockets which may be ½41 to 1½″ high from the string(s) to where the bulb may be seen. The HLCS changes this typical structure in two ways. First, is it adds a compacting guide to all the sockets (FIGS. 1 and 2). The guide is a screw shaped cone atop a cylinder. The guide has a hole running through the center. The second structural change is a nylon guide cord running through the hole in the guides (FIG. 3). When the light string is used, the cord and guide do nothing. However, when the string is to be packaged or stored, the string may be pulled while pushing the light socket furthest to one end “compacting” the lights together in a uniform way. Thus they will not tangle and break, allowing their easy use for the next holiday season.

Manufacture would differ only in shaping the socket and threading of the nylon cord. Changing the plastic mold would incorporate the new shape of the guide into the socket. The guide cord would be run through the guides with robotics or labor.

I claim:

1. A self-aligning light string storage and packaging system consisting of an additional compacting guide on the light socket. The compacting guide would be as wide as the widest part of the light socket as measured perpendicular to the axis with radial symmetry. The compacting guide in no way changes the electrical engineering of the bulb socket. The compacting guide would be shaped with one end as a cone and about two thirds of its length as a cylinder. The cone part would have a handedness like a screw and the base would be hollowed with an identical handedness, such that it would accept the male end of another cone. The shape would be similar to a short fat crayon or bullet, with the screw handed cone at the male end and a similar hollow at the female end, such that they could mate. Through the guides would stretch a thin string running through the holes parallel to and inside of the guides. Grasping the guide, one could pull the string, thus compacting all the guides and allowing them to serve as a structural stabilizer for packaging and/or for consumer storage. The compacted string could be kept sturdy by a clip forcing the end of the lights together crimping on the string, or by winding the excess guide cord between the first and last socket.

2. A compacting guide in claim one as a molded part of the socket in no way altering the electrical engineering of the socket.

3. In claim 2, the device is made from plastic

4. In claim 2, the device matches the color of the wiring and sockets (often green).

5. In claim 2, the device has a cone on one end atop a cylinder that has a diameter slightly greater than that of the base of the cone.

6. In claim 2, the device, in particular the cone, is 1/3 the total length of the guide in 2, allowing for the cylinder to be approximately 2/3 of its entire length.

7. In claim 2, the device, the cylinder portion in particular, is of a length slightly greater than the maximum width of the light and socket assembly.

8. In claim 2, the device's axis is at 90° to the axis of the bulb socket assembly and is located in the middle from the top (where the bulb adjoins) to the bottom (where wires traditionally adjoin) of the socket molding.

9. In claim 2, the device, the female end of the cylinder in particular, has a space that allows the insertion of the cone (male end) of another identical guide assembly described in 2.

10. In claim 2, the device, the female end in particular, possesses a small ledge resulting from its design allowing for the mating to the male end (cone) with a base slightly smaller in diameter (5% smaller) than that of the female end (cylinder).

11. In claim 2, two of the devices adjoined appear as one cylinder of twice the length of the individual cylinders with one cone hidden from view in the female end of the first device with its male end still in view.

12. In claim 2, through the device runs a small hole (5%) diameter beginning at the male end and running axially through the female end.

13. In claim 2, through the device and hole runs a nylon guide string of a circumference identical to that of the hole.

14. In claim 2, through all devices, the same guide string runs, in the order in which they exist on the light string.

15. In claim 2, the device has the male end and female end designed with complementary right-handed screw topography, with the turn of half a period over the length of the cone.

16. In claim 2, the devices' relative position of the screw topography to the bulb socket assemblies is identical for all compacting guides, yielding alignment of bulbs when the devices are brought together by screwing them into one another.

16. In claim 2, the device's universal screw topography uniquely aligns the lights in a parallel row, all bulbs upright.

17. In claim 2, the device allows the socket/guide assemblies to flow freely along the length of the nylon string.

18. A method for packaging and storing light strings using the light string itself as a scaffold for an apparatus, which uses compacting guides attached to the bulb/socket parts of the light string. Then, having a guide on which the compacting guides are all attached and the use of this guide pushing the compacting guides against each, such that they, by lining up, will align their attached bulb/sockets.
